(19) United States
(12) Patent Application Publication
(10) Pub. No.: US 2011/0274096 A1
(43) Pub. Date: Nov. 10, 2011

(54) HANDHELD WIRELESS COMMUNICATION DEVICES AND EXPANDABLE ANTENNAS THEREOF

(75) Inventors: CHO-MIN NI, Hsinchu City (TW); Yu-Chun Liu, HsinChu (TW)

(73) Assignee: Accton Wireless Broadband Corp., HsinChu (TW)

(21) Appl. No.: 13/101,383

(22) Filed: May 5, 2011

(30) Foreign Application Priority Data
May 6, 2010 (TW) 099208401

(51) Int. Cl. H04W 4/00; H04W 84/02; H01Q 1/24

(52) U.S. Cl. 370/338; 343/702; 370/328

(57) ABSTRACT

The present invention relates to a wireless communication system, comprising: a wireless communication device; and an external mechanism; wherein the wireless communication device comprises: a wireless media access controller; an antenna selector, being a switch of a switchable antenna; an antenna connector, connecting the external mechanism; and a built-in antenna; wherein the external mechanism comprises: a support mechanism; and an external antenna supported by the support mechanism.

### FIELD OF THE INVENTION

The present invention generally relates to a wireless communication system and, more particularly, to a wireless communication system having high-quality communication and the convenience and portability with the separated operation.

### BACKGROUND OF THE INVENTION

Mobility is firstly important for the wireless communicaton products. General speaking, the size of antenna in the wireless communication product is designed to be larger in order to obtain high-quality communication. However, the disadvantage of the antenna with large size is poor mobility.

Today, the antenna is designed to be small and thin for advancing the convenience and portability. Thereby, the gain of the deigned antenna is too small so that the communication quality is decreased.

It need not use the antenna with high cost and large size when the wireless signal is strong enough. On the contrary, it also hopes the communiciaton quality is good when the wireless signal is weak. Therefore, there is need in providing a wireless communication system and, more particularly, to a wireless communication system having high-quality communication and the convenience and portability with the separated operation is capable of improving a dilemma of increasing the size of antenna or advancing the communcitaion quality.

### SUMMARY OF THE INVENTION

The present invention provides a wireless communication system, comprising: a wireless communication device and an external mechanism; wherein the wireless communication device comprises a wireless media access controller; an antenna selector, being a switch of a switchable antenna; an antenna connector, connecting the external mechanism; and a built-in antenna; wherein the external mechanism comprises: a support mechanism; and an external antenna supported by the support mechanism.

The present invention further provides a wirless communication system, comprising: a host; a second antenna; and a wireless media access controller, comprising a first antenna; wherein the wireless media access controller connects the host via a general serial bus/the second antenna.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The objects and spirits of the embodiments of the present invention will be readily understood by the accompanying drawings and detailed descriptions, wherein:

FIG. 1 is a schematic diagram of a wireless communication system 10 according to a first embodiment of the present invention;

FIG. 2 is a schematic diagram of a wireless communication system 20 according to another preferred embodiment of the present invention;

FIG. 3 is a schematic diagram of a wireless communication system 20 according to another preferred embodiment of the present invention; and

FIG. 4 is a solid diagram of FIG. 1 in the present invention.

### DETAILED DESCRIPTION OF THE PREFERRED EMBODIMENT

The present invention can be exemplified but not limited by various embodiments as described hereinafter.

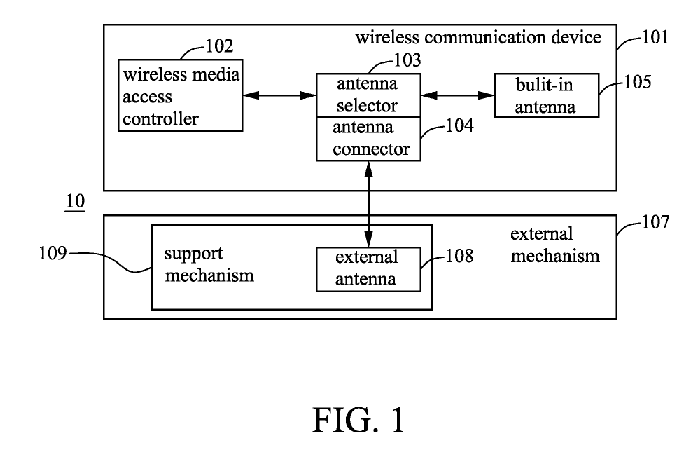

FIG. 1 is a schematic diagram of a wireless communication system 10 according to a first embodiment of the present invention. Specifically, the wireless communication 10 has high-quality communication and the convenience and portability with the separated operation. The wireless communication system 10 comprises a wireless communication device 101 and an external mechanism 107. Wherein the wireless communication device comprises a wireless media access controller 102, an antenna selector 103 which is a switch of a switchable antenna, an antenna connector 104 connected the external mechanism 107 and a built-in antenna 105. Specifically, the external mechanism 107 comprises a support mechanism 109 and an external antenna 108 supported by the support mechanism.

Preferably, the wireless communication system is selected from one of the following: WiFi (IEEE 802.1 specification), Worldwide Interoperability for Microwave Access (Wimax), 3G (third communication technology), 4G (fourth communication technology), Long Term Evolution (LTE), wireless High Definitiaon Multimedia Interface (HDMI), general serial bus/Ethernet, Dongle and IEEE 1394.

Preferably, the antenna selector is selected from one of the following: the mechanical type and the electronic detectiion type

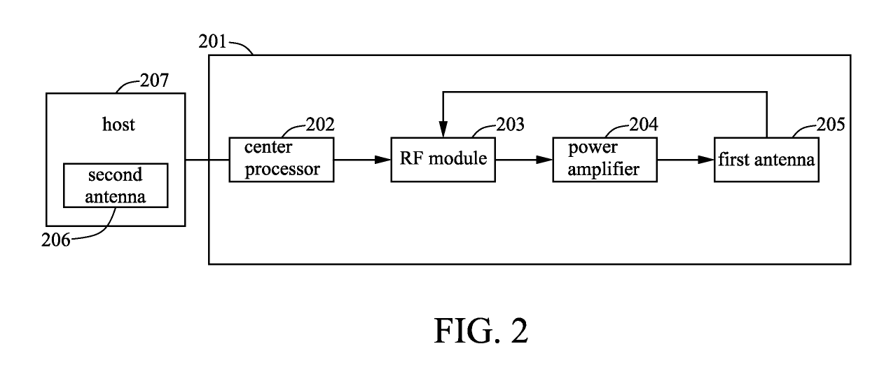

FIG. 2 is a schematic diagram of a wireless communication system 20 according to another preferred embodiment of the present invention. The wireless communication system 20 comprises a wireless media access controller 201, which further includes a center processor 202, a RF module 203 and a power amplifier 204.

The power amplifier 204 selects a first antenna 205 and a second antenna 206 via the antenna selector (not shown in the FIG. 2) according to the actual requirement.

The wireless media access controller 201 connects a host 207, and the host 207 may be a NoteBook PC/Desktop PC.

When the host 207 connects the center processor 202, the center processor 202 can detect the second antenna 206 placed on the host 207 and an input/output signal of the RF module 203 may input/output to the center processor 202 via the second antenna 206 placed on the host 207. At the same time, the center processor 202 informs the RF module 203 that the input/output signal will not pass through the first antenna 205 or the power amplifier 204.

When the host 207 does not connect the center processor 202, the center processor 202 can not detect the second antenna 206 placed on the host 207 and an input/output signal of the RF module 203 may not input/output to the center processor 202 via the second antenna 206 placed on the host 207. At the same time, the center processor 202 informs the RF module 203 that the input/output signal will pass through the first antenna 205 and the power amplifier 204.

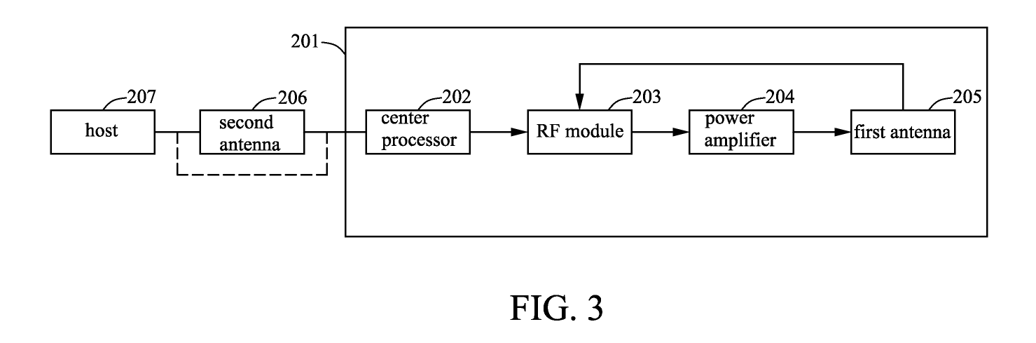

As shown in FIG. 3, the host 207 and the second antenna 206 are separated elements. As showin FIG. 2, the center processor 202 may be directly coupled to the host 207 or may be coupled to the host 207 via the second antenna 206.

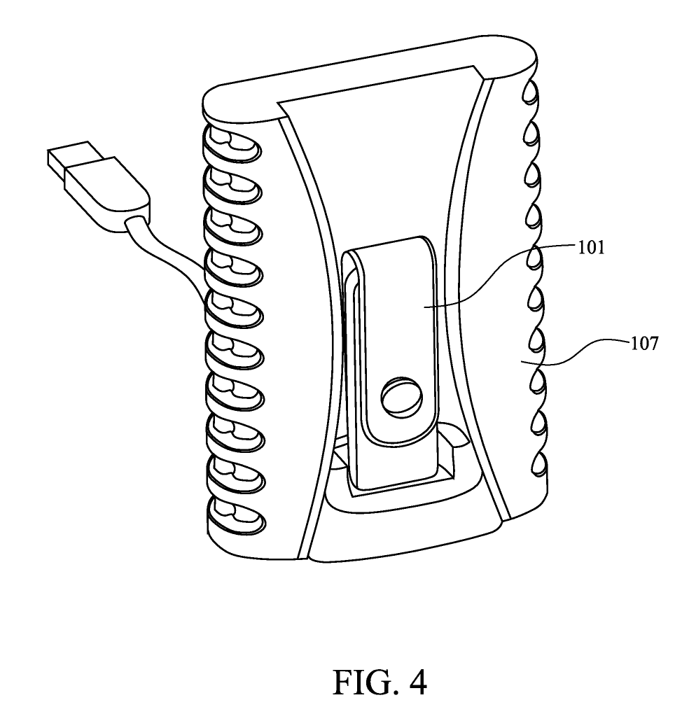

FIG. 4 is a solid diagram of FIG. 1 in the present invention. The wireless communication device 101 is inserted in the external mechanism 107. The external mechanism 107 connects a host via a bus line, such as the general serial bus line.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A wireless communication system, comprising:
a wireless communication device; and
an external mechanism;
wherein the wireless communication device comprises:
a wireless media access controller;
an antenna selector, being a switch of a switchable antenna;
an antenna connector, connecting the external mechanism; and
a built-in antenna;
wherein the external mechanism comprises:
a support mechanism; and
an external antenna supported by the support mechanism.

2. The wireless communication system as recited in claim 1, wherein the wireless communication system is selected from one of the following: WiFi, Wimax, 3G, 4G, LTE, wireless HDMI, general serial bus/Ethernet, Dongle and IEEE1394.

3. The wireless communication system as recited in claim 1, wherein the antenna selecotr is selected from one of the following: a mechanical type and an electronic detection type.

4. The wireless communication system as recited in claim 1, wherein the wireless media access controller further comprises a center processor.

5. The wireless communication system as recited in claim 1, wherein the wireless media access controller further comprises a RF module.

6. The wireless communication system as recited in claim 1, wherein the wireless media access controller further comprises a power amplifier.

7. The wireless communication system as recited in claim 1, wherein the wireless media access controller further comprises a general serial bus line.

8. A wirless communication system, comprising:
a host;
a second antenna; and
a wireless media access controller, comprising a first antenna;
wherein the wireless media access controller connects the host via a general serial bus/the second antenna.

9. The wireless communication system as recited in claim 8, wherein the wireless media access controller outputs/receives a signal via the second antenna when the wireless media acess controller connects the host.

10. The wireless communication system as recited in claim 8, wherein the wireless media access controller outputs/receives a signal via the first antenna when the wireless media acess controller does not connect the host.

11. The wireless communication system as recited in claim 8, wherein the wireless media access controller further comprises a center processor, a RF module and a power amplifier.

12. The wireless communication system as recited in claim 8, wherein the host is a Notebook PC or Desktop PC.
